(19) United States
(12) Patent Application Publication
(10) Pub. No.: US 2022/0057231 A1
(43) Pub. Date: Feb. 24, 2022

(54) METHODS AND APPARATUSES FOR DETECTING MAP CALIBRATION ERRORS

(71) Applicant: SENSETIME GROUP LIMITED, Shatin (CN)

(72) Inventors: Zheng MA, Hong Kong (CN); Zeyu WANG, Hong Kong (CN); Lei DU, Hong Kong (CN); Chunxiao LIU, Hong Kong (CN); Jianping SHI, Hong Kong (CN)

(21) Appl. No.: 17/521,308

(22) Filed: Nov. 8, 2021

Related U.S. Application Data
(63) Continuation of application No. PCT/CN2021/076757, filed on Feb. 18, 2021.

(30) Foreign Application Priority Data
Feb. 17, 2020 (CN) 202010096418.2

(51) Int. Cl. G01C 21/00; G01C 21/36

(52) U.S. Cl. CPC G01C 21/3867; G01C 21/367; G01C 21/3632

(57) ABSTRACT

Embodiments of the present description provide methods and apparatuses for detecting map calibration errors. In one aspect, a method includes: acquiring a map including at least one map element, determining at least one of feature information of the at least one map element or a navigation line according to the map, and determining whether a map element is calibrated wrongly according to the at least one of the feature information or the navigation line.

### CROSS-REFERENCE TO RELATED APPLICATION

The present application is a continuation of International Application No. PCT/CN2021/076757, field on Feb. 18, 2021, which claims priority to Chinese Patent Application No. 202010096418.2, filed on Feb. 17, 2020, all of which are incorporated herein by reference in their entireties.

### TECHNICAL FIELD

The present disclosure relates to the field of unmanned technology, and in particular to methods and apparatuses for detecting a map calibration error.

### BACKGROUND

A high definition map is one of important parts of driverless technology. At present, the production of a high definition map mainly relies on manually collecting calibration data, and manually troubleshooting a calibration error with some visualization tools.

### SUMMARY

Implementations of the present disclosure provide methods and apparatuses for detecting map calibration errors.

Specifically, the present disclosure is realized through the following technical solutions.

According to a first aspect of embodiments of the present disclosure, a method of detecting a map calibration error is provided, including: acquiring a map including at least one map element; determining at least one of feature information of the at least one map element or a navigation line according to the map; and determining whether a map element is calibrated wrongly (or wrongly calibrated) according to the at least one of the feature information or the navigation line.

In some embodiments, the at least one map element includes a plurality of map points, and the feature information includes relative position information between each two of the plurality of map points, where determining whether the map element is calibrated wrongly according to the at least one of the feature information or the navigation line includes: determining whether there is a duplicate map point on the map according to the relative position information associated with the plurality of map points, and where the method further includes: in response to determining that there is a duplicate map point on the map, determining that the duplicate map point is calibrated wrongly.

In some embodiments, the at least one map element includes a junction, and the feature information includes lane link information of the junction, where determining whether the map element is calibrated wrongly according to the at least one of the feature information or the navigation line includes: determining whether lane link information of the junction is empty, and where the method further includes: in response to determining that the lank link information of the junction is empty, determining that the junction is calibrated wrongly.

In some embodiments, the at least one map element includes at least one of boundary points of a junction or boundary points of a section, and the feature information includes a geometric feature of a boundary constituted by the boundary points, where determining whether the map element is calibrated wrongly according to the at least one of the feature information or the navigation line includes: determining whether the boundary constitutes a predetermined polygon according to the geometric feature; and where the method further includes: in response to determining that the boundary does not constitute the predetermined polygon, determining that the boundary is calibrated wrongly.

In some embodiments, the at least one map element includes a plurality of sections in a road, where the feature information includes a first distance between each of the plurality of sections and a predecessor junction of the road and a second distance between each of the plurality of sections and a successor junction of the road, where each of the plurality of sections has a respective section identifier increasing along a direction from the predecessor junction to the successor junction; and where determining whether the map element is calibrated wrongly according to the at least one of the feature information or the navigation line includes: determining, among the plurality of sections, whether a section fails to meet a predetermined constraint condition, where the predetermined constraint condition includes: the section having a larger first distance than a first section with a first section identifier smaller than a section identifier of the section, and the section having a smaller second distance than a second section with a second section identifier smaller than the section identifier of the section.

In some embodiments, the method further includes: in response to determining that a map element is calibrated wrongly, determining a calibration error type of the map element that is calibrated wrongly; determining an alarm level according to the calibration error type; and outputting alarm information corresponding to the alarm level.

In some embodiments, determining the at least one of the feature information of the at least one map element or the navigation line according to the map includes: selecting a starting point, an ending point, and a passing point from the map; and generating the navigation line according to the starting point, the ending point, and the passing point.

In some embodiments, selecting the starting point, the ending point, and the passing point from the map includes: selecting, according to weights of one or more target areas divided from the map, the starting point, the ending point, and the passing point from the one or more target areas, where a target area includes a road or a junction.

In some embodiments, the method further includes one of: determining the weights of the one or more target areas according to corresponding frequencies of use of the one or more target areas; or randomly allocating the weights of the one or more target areas according to a predetermined distribution function.

In some embodiments, determining whether the map element is calibrated wrongly according to the at least one of the feature information or the navigation line includes: determining whether there is an intersection point between the navigation line and the map element, and where the method further includes: in response to determining that there is an intersection point between the navigation line and the map element, determining that the map element intersected with the navigation line is calibrated wrongly.

In some embodiments, determining whether the map element is calibrated wrongly according to the at least one of the feature information or the navigation line includes: determining whether there is a navigation point with a curvature greater than a predetermined value on the navigation line; and in response to determining that there is a navigation point with a curvature greater than the predetermined value on the navigation line, determining whether the map element corresponds to the navigation point and is in an area where the navigation point is located, where the method further includes: in response to determining that the map element corresponds to the navigation point and is in the area where the navigation point is located, determining that the map element is calibrated wrongly.

According to a second aspect of the embodiments of the present disclosure, there is provided a non-transitory computer-readable storage medium coupled to at least one processor having machine-executable instructions stored thereon that, when executed by the at least one processor, cause the at least one processor to perform the method according to any one of the embodiments.

According to a third aspect of the embodiments of the present disclosure, there is provided a computer device including at least one processor; and at least one non-transitory machine readable storage medium coupled to the at least one processor having machine-executable instructions stored thereon that, when executed by the at least one processor, cause the at least one processor to perform operations including: acquiring a map including at least one map element; determining at least one of feature information of the at least one map element or a navigation line according to the map; and determining whether a map element is calibrated wrongly according to the at least one of the feature information of the at least one map element or the navigation line according to the map.

In some embodiments, the at least one map element includes a plurality of map points, and the feature information includes relative position information between each two of the plurality of map points, where the operations include: determining whether there is a duplicate map point on the map according to the relative position information associated with the plurality of map points; and in response to determining that there is a duplicate map point on the map, determining that the duplicate map point is calibrated wrongly.

In some embodiments, the at least one map element includes a junction, and the feature information includes lane link information of the junction, and where the operations include: determining whether lane link information of the junction is empty, and in response to determining that the lank link information of the junction is empty, determining that the junction is calibrated wrongly.

In some embodiments, the at least one map element includes at least one of boundary points of a junction or boundary points of a section, and the feature information includes a geometric feature of a boundary constituted by the boundary points, where the operations include: determining whether the boundary constitutes a predetermined polygon according to the geometric feature; and in response to determining that the boundary does not constitute the predetermined polygon, determining that the boundary is calibrated wrongly.

In some embodiments, the at least one map element includes a plurality of sections in a road, where the feature information includes a first distance between each of the plurality of sections and a predecessor junction of the road and a second distance between each of the plurality of sections and a successor junction of the road, where each of the plurality of sections has a respective section identifier increasing along a direction from the predecessor junction to the successor junction; and where determining whether the map element is calibrated wrongly according to the at least one of the feature information or the navigation line includes: determining, among the plurality of sections, whether a section fails to meet a predetermined constraint condition, where the predetermined constraint condition includes: the section having a larger first distance than a first section with a first section identifier smaller than a section identifier of the section, and the section having a smaller second distance than a second section with a second section identifier smaller than the section identifier of the section.

In some embodiments, the operations further include: in response to determining that a map element is calibrated wrongly, determining a calibration error type of the map element that is calibrated wrongly; determining an alarm level according to the calibration error type; and outputting alarm information corresponding to the alarm level.

In some embodiments, determining the at least one of the feature information of the at least one map element or the navigation line according to the map includes: selecting a starting point, an ending point, and a passing point from the map; and generating the navigation line according to the starting point, the ending point, and the passing point.

In some embodiments, the operations include: determining whether there is an intersection point between the navigation line and the map element; and in response to determining that there is an intersection point between the navigation line and the map element, determining that the map element intersected with the navigation line is calibrated wrongly.

In the embodiments of the present disclosure, by acquiring feature information of one or more map elements on a map, or determining at least one navigation line according to the map, and then determining whether a map element is calibrated wrongly according to the feature information or the navigation line, automated detection on a map calibration error can be realized, which reduces the cost of detection and improves the accuracy of detection.

It should be understood that the general description and the following detailed description are only exemplary and explanatory, and cannot limit the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the solutions of the disclosure.

FIG. 1 is a flow chart illustrating a method of detecting a map calibration error according to an embodiment of the present disclosure.

FIG. 2 is a schematic diagram illustrating map elements according to an embodiment of the present disclosure.

FIG. 3A and FIG. 3B illustrate a comparison of correctly calibrated boundary points and wrongly calibrated boundary points according to an embodiment of the present disclosure.

FIG. 4A and FIG. 4B illustrate a comparison of correctly calibrated sections and wrongly calibrated sections according to an embodiment of the present disclosure.

FIG. 5 is a flow chart illustrating a method of detecting a map calibration error based on a navigation line according to an embodiment of the present disclosure.

FIG. 6A and FIG. 6B illustrate a comparison of a correct calibration and a wrong calibration according to an embodiment of the present disclosure.

FIG. 7A and FIG. 7B illustrate a comparison of a correct calibration and a wrong calibration according to another embodiment of the present disclosure.

FIG. 8 is a block diagram illustrating an apparatus for detecting a map calibration error according to an embodiment of the present disclosure.

FIG. 9 is a block diagram of a computer device for implementing the method of the present disclosure according to an embodiment of the present disclosure.

### DETAILED DESCRIPTION OF THE EMBODIMENTS

Exemplary embodiments will be described in detail herein, with the illustrations thereof represented in the drawings. When the following descriptions involve the drawings, like numerals in different drawings refer to like or similar elements unless otherwise indicated. The specific manner described in the following exemplary embodiments does not represent all embodiments consistent with the present disclosure. Rather, they are merely examples of apparatuses and methods consistent with some aspects of the present disclosure as detailed in the appended claims.

The terminology used in the present disclosure is for the purpose of describing particular embodiments only and is not intended to limit the present disclosure. The singular forms ‘a’, ‘said’ and ‘the’ used in the present disclosure and the appended claims are also intended to include the majority of forms unless the context clearly indicates other meanings. It should also be understood that the term ‘and/or’ as used herein refers to and includes any or all possible combinations of one or more associated listed items. In addition, the term “at least one” as used herein means any one of multiple or any combination of at least two of multiple.

It should be understood that although terms like first, second, third, etc. may be used to describe various information in this disclosure, the information should not be limited to these terms. These terms are only used to distinguish the same type of information from each other. For example, without departing from the scope of the present disclosure, first information may also be referred to as second information, and similarly, second information may also be referred to as first information. Depending on the context, the word “if” as used herein may be interpreted as “when” or “upon” or “in response to determining”.

In order to enable those skilled in the art to better understand the technical solutions in the embodiments of the present disclosure, and to enable the above-described objects, features and advantages of the embodiments of the present disclosure to be more clearly understandable, the technical solutions in the embodiments of the present disclosure are described in further detail below in conjunction with the accompanying drawings.

A map can be used to record locations of destinations in an area (for example, a district, a city, a province, etc.) and a path from one destination (a starting point) to another destination (an ending point). During the driving process of a smart driving equipment, a map can help the smart driving equipment, such as an unmanned vehicle, a mobile robot, etc., plan a navigation path and a driving operation, as well as accurately identify a traffic sign. As the smart driving equipment lacks inherent visual and logical capabilities of a human driver, a high definition map is needed to assist the smart driving equipment for making a driving decision and a driving plan, and taking control in a driverless scenario. It can be seen that the high definition map is an indispensable part of unmanned driving, and the calibration accuracy for each map element on the high definition map has an important impact on the safety of unmanned driving. Therefore, it is necessary to detect a calibration error in a high definition map. Although there were some semi-automatic calibration methods, the correctness of a calibration result still needs manual checking in the end, which may lead to high detection costs and low detection accuracy.

Based on this, embodiments of the present disclosure provide a method of detecting a map calibration error. The method can be applied to a computing device (for example, a terminal or a server). As shown in FIG. 1, the method includes the following steps.

At step S101, a map which includes at least one map element is acquired.

At step S102, feature information of the at least one map element is determined, or a navigation line is determined according to the map.

At step S103, whether a map element is calibrated wrongly is determined according to the feature information or the navigation line.

Compared with a traditional map, a high definition map has higher accuracy (the high definition map has precision of at least centimeter level) and more data dimensions. The traditional map only records road-level data, such as a shape, a slope, a curvature of a road, etc.; while the high definition map further adds data related to a lane attribute (lane line type, lane width, etc.). A high definition map often includes a large number of map elements. The map element in the embodiments of the present disclosure includes, but is not limited to, at least any one of the following map elements on a high definition map: a point, a junction, a lane, a road, and a section, etc.

Each map element indicates a functional unit with a certain function on the high definition map. A point is the smallest unit that constitutes other map elements, and each of the other map elements (for example, a junction) is composed of a plurality of points. A junction indicates an intersection area of a plurality of roads for linking the plurality of roads, and represents a lane-level relationship among the plurality of roads intersecting in the same intersection area. That is, whether one can drive from road I to road II, and from which lane of road I to which lane of road II. A lane indicates a travelable path for an intelligent driving device, and each road includes one or more lanes. A road is a passage between two destinations and can be divided into a plurality of sections. For example, when the number of lanes changes, an area before and after the change on a road can be set to two different sections. For another example, when a lane line changes between solid and dashed (changing from a solid line to a dashed line, or from a dashed line to a solid line), an area before and after the change on a road can be set to two different sections.

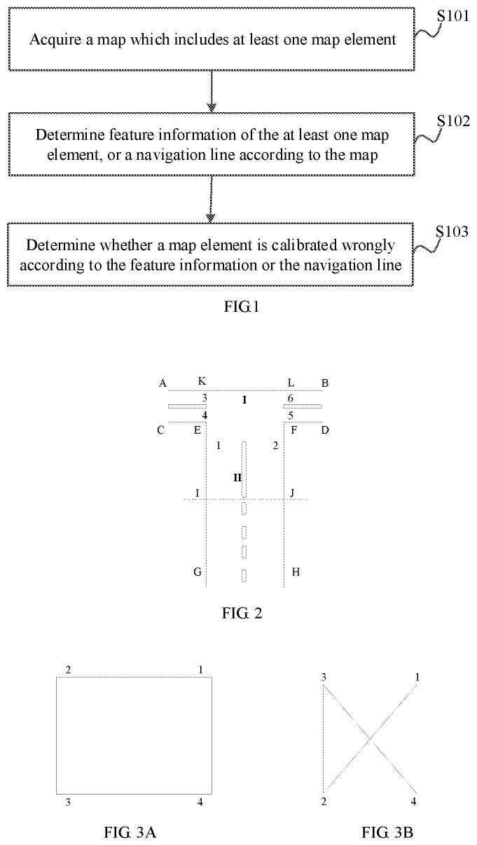

A schematic diagram of map elements according to an embodiment is shown in FIG. 2, where a horizontal path among ABCD is one road (road I), and a longitudinal path among EFGH is another road (road II). On road II, an area corresponding to EFIJ is one section and an area corresponding to GHIJ is another section. Road II includes two lanes, lane 1 and lane 2. An area among EFLK is a junction, which is an intersection point of road I and road II.

In a case that feature information of at least one map element on the map is acquired at step S102, then at step S103, whether the map element is calibrated wrongly is determined according to the feature information. In a case that a navigation line is determined according to the map at step S102, then at step S103, whether the map element is calibrated wrongly is determined according to the navigation line.

In a case of determining whether the map element is incorrectly calibrated according to the feature information, the feature information may be feature information related to path navigation. The feature information in the embodiments of the present disclosure may include, but is not limited to, at least any one of the following: relative position information of map points, lane link information of a junction, a geometric feature of a boundary of a junction, a geometric feature of a boundary of a section, distance information between a section and a predecessor junction of a road where the section is located, distance information between a section and a successor junction of a road where the section is located, etc. If a certain map element is incorrectly calibrated, the feature information of the map element will usually be abnormal. Once feature information of one or some map elements is abnormal, the path navigation during driving may be affected, and even the safety of driving will be affected.

Therefore, whether the map element is calibrated wrongly can be determined according to the feature information. Specifically, feature information of a selected map element can be compared with a rule set for the feature information to determine whether the feature information meets the set rule. If the determination indicates not satisfying, the map element is determined as calibrated wrongly.

In a case that the map element includes map points, the feature information includes relative position information between each two of the map points. Whether there is a duplicate map point on the map can be determined according to pieces of the relative position information. If the determination indicates existing, the duplicate map point is determined as calibrated wrongly.

When calibrating a high definition map, longitude and latitude coordinates of each map point are stored, and relative position information between two map points can be determined based on the longitude and latitude coordinates. If a difference between longitude coordinates of map point a and map point b is within a predetermined longitude range, and a difference between latitude coordinates of map point a and map point b is within a predetermined latitude range, map point a and map point b are determined as duplicate map points, thereby detecting that map point a and/or map point b is incorrectly calibrated.

In a case that the map element includes a junction, the feature information includes lane link information of the junction, for example, information indicating that one can drive from one lane to another lane. If lane link information of a junction is empty, the junction can be determined as calibrated wrongly.

In a case that the map element includes boundary points of a junction or boundary points of a section, and the feature information includes a geometric feature of a boundary constituted by the boundary points. Whether the boundary constitutes a predetermined polygon can be determined according to the geometric feature. If the determination indicates no, one or more boundary points of the boundary are determined as wrongly calibrated. The geometric feature can be a geometric shape and the predetermined polygon can be a rectangle, a circle, etc.

In general, a boundary enclosed by all boundary points involved in a junction or a section is of a regular shape, such as a rectangle, a circle, etc. Identification information (e.g., a serial number) of each boundary point is stored when calibrating a high definition map, and a calibration error of one or more boundary points is generally caused by a wrong order of calibrating each boundary point. Therefore, the boundary points can be connected according to their serial numbers, and if the boundary points form a boundary having an intersection point other than these boundary points, the boundary is determined as calibrated wrongly.

A comparison of correctly calibrated boundary points and wrongly calibrated boundary points according to an embodiment is shown in FIG. 3A and FIG. 3B, where four boundary points with serial numbers 1 to 4 are included. In FIG. 3A, the boundary intersects only at these boundary points, and thus each boundary point is the correctly calibrated boundary point; while in FIG. 3B, there is another intersection point besides the boundary points, and thus there is a calibration error.

In a case that the map element includes a plurality of sections in a road, the feature information includes a first distance between each of the sections and a predecessor junction of the road and a second distance between each of the sections and a successor junction of the road. In a case that the first distance and/or the second distance does not meet a predetermined constraint condition, the road is determined as calibrated wrongly. The predetermined constraint condition includes: the first distance increases as the numbering of the sections increases, and the second distance decreases as the numbering of the sections increases.

In a high definition map, each road has a road identifier (ID) to uniquely identify the road. A predecessor junction of a road is a junction between the road and a road with a road ID smaller than the road, and a successor junction is a junction between the road and a road with a road ID larger than the road. Generally speaking, each section on the high definition map is sequentially numbered, so it will satisfy that: a section with serial number (or section identifier) 1 is the closest to a predecessor junction and the farthest from a successor junction; a section with serial number 2 is the next closest to the predecessor junction and the next farthest from the successor junction; . . . ; and so on. If the above conditions are not satisfied, the calibration is wrong.

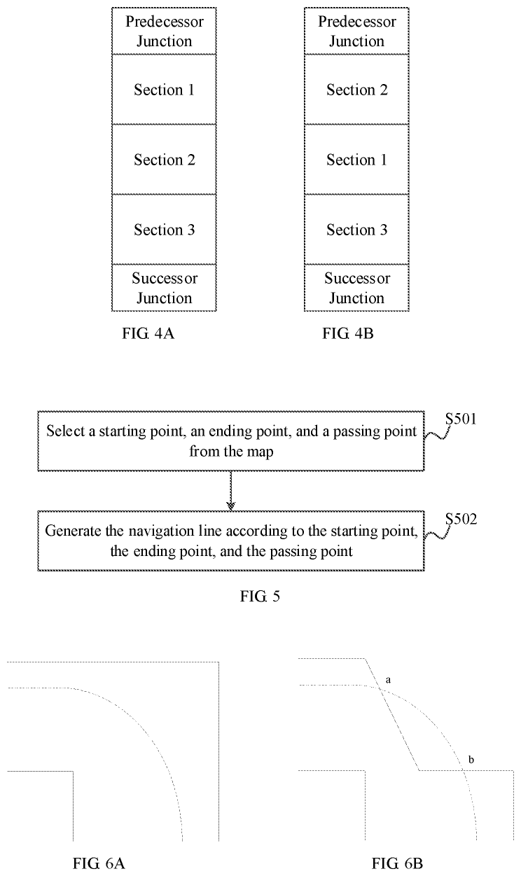

A comparison of correctly calibrated sections and wrongly calibrated sections according to an embodiment is shown in FIG. 4A and FIG. 4B. It can be seen that each section in FIG. 4A meets the constraint condition and is therefore the correctly calibrated section, while for the sections in FIG. 4B, section 1 and section 2 do not meet the constraint condition, so section 1 and section 2 are wrongly calibrated.

In some embodiments, alarm information can be output according to the calibration error. Specifically, in a case that the map element is calibrated wrongly, a calibration error type of the map element can be determined. An alarm level is determined according to the calibration error type, and alarm information corresponding to the alarm level is output.

The alarm level is used to characterize a degree of an impact of a calibration error on the driving of a smart mobile equipment. In some embodiments, at least two alarm levels can be set. Taking a case of two alarm levels as an example, for an error type that does not affect driving safety, a first alarm level which is represented by a “warning” field can be output. For an error type that affects driving safety, a second alarm level which is represented by an “error” field can be output. The first alarm level is lower than the second alarm level. A control center can determine the order of processing calibration errors according to their alarm level. A calibration error with a higher alarm level can be handled first. Thus, the impact of calibration errors on the driving safety can be reduced as much as possible.

For example, in a case that relative position information of a map point is abnormal, a road direction may be caused to change at a section where the relative position information is abnormal, i.e., a calibrated road direction is different from an actual road direction (a road direction is calculated based on relative positions of points on the road). For another example, in a case that lane link information of a junction is abnormal, which may cause a smart driving equipment not being able to change lanes properly. The smart driving equipment may include a self-driving vehicle, a vehicle and a robot equipped with ADAS (Advanced Driving Assistance System), etc. Still taking the two roads in FIG. 2 as an example, assuming that a smart driving equipment can drive from lane 1 on road II to lane 4 on road I under actual circumstances, if lane link information of junction EFLK is abnormal, lane link information between lane 1 and lane 4 may not be included in the lane link information of junction EFLK, thus causing the smart driving equipment to fail to drive from lane 1 to lane 4 during driving. Since the above two calibration errors may not affect the safety of driving, alarm information with the “warning” level can be output when the above two calibration errors occur.

For another example, in a case that a geometric feature of a boundary of a junction or a section is abnormal, an error in navigation path planning may be caused. For example, if vertices of a junction polygon are in a wrong order, the junction may be closed, thus making it impossible to plan a normal route or causing a planned route to be shifted due to detouring one or more abnormal points on the geometric boundary. If distance information between one section and a predecessor junction and a successor junction of a road where the section is located is abnormal, distance measurement from the navigation line to the junction can be wrong, thus affecting a deceleration alarm function for approaching a junction of the smart driving equipment. In some situations, for example, a vehicle speed is too high and an actual distance from a smart driving equipment to a junction is shorter than a calibration distance, an accident may be easily caused due to untimely slowing down the smart driving equipment. Since the above two calibration errors may affect the safety of driving, alarm information with the “error” level can be output when the above two calibration errors occur.

In a case of determining whether a map element is wrongly calibrated based on a navigation line, the navigation line can be determined based on the map using steps shown in FIG. 5, the steps including steps S501 to S502.

At step S501, a starting point, an ending point, and a passing point are selected from the map.

At step S502, the navigation line is generated according to the starting point, the ending point, and the passing point.

At step S501, the starting point indicates a starting place of the navigation, the ending point indicates a destination of the navigation and the passing point refers to a point on a passable path between the starting point and the ending point. The number of passing points can be one or more.

In some embodiments, the starting point, the ending point, and the passing point are selected from target areas according to a weight of each of the target areas on the map, where a target area can be a road or a junction, and the weight is for characterizing how often the target area is used. An area with a relatively large volume of people and/or traffic can be considered as an area used more frequently, and can be allocated a higher weight; conversely, an area with a relatively small volume of people and traffic can be considered as an area used less frequently, and can be allocated a lower weight. Therefore, the weight is predetermined according to the frequency of use of the target area. In this way, the correctness of a highly used section can be detected first, thereby ensuring a frequency of updating a high definition map within limited time.

In some other embodiments, the weights of the target areas may be randomly allocated according to a predetermined distribution function. The distribution function may include an exponential distribution, a normal distribution, a Poisson distribution, etc., which is not limited in the present disclosure. When the weights are set, the starting point, the ending point, and the passing point can be selected first from areas with higher weights, so that a calibration error in these areas can be detected.

At step S502, starting from the starting point, a navigation point can be generated every certain distance (for example, 1 meter or 5 meters) until the ending point is reached. The navigation line is a lane-level navigation path, that is, according to the navigation line, each lane on the passable path from the starting point to the ending point can be determined. The navigation line can be generated according to the navigation points, and a navigation line between two adjacent navigation points may be called a navigation line segment.

In a case that there is an intersection point between the navigation line and a map element, the map element is determined as calibrated wrongly. A comparison of a correct calibration and a wrong calibration determined based on a navigation line according to an embodiment of the present disclosure is shown in FIG. 6A and FIG. 6B, where a dashed line represents a navigation line and a solid line represents a road element. For the map element in FIG. 6A, each part on the navigation line is inside the map element indicated by the solid line, and therefore, the map element is calibrated correctly. For the map element in FIG. 6B, a part of the navigation line (e.g., line segment ab) is not inside the map element indicated by the solid line, and therefore, a part of the map element that intersects with line segment ab is determined as calibrated wrongly.

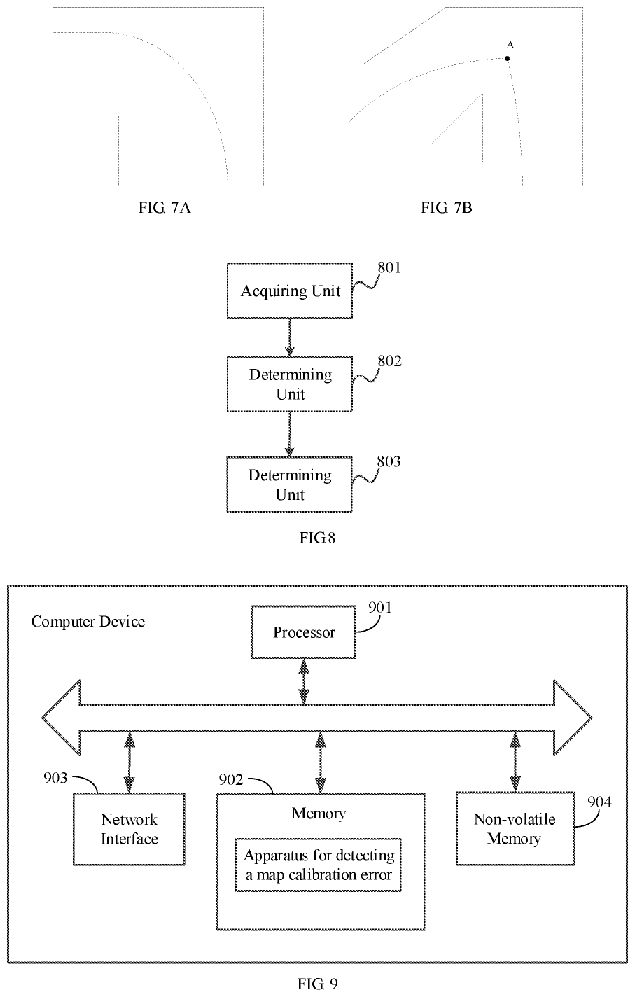

In some embodiments, a calibration error can further be detected based on a curvature of each navigation point on the navigation line. A curvature of a navigation point is used to characterize a turning angle of a smart driving equipment, and the angle is a value not greater than a predetermined angle threshold. Therefore, whether there is a navigation point with a curvature greater than a predetermined value on the navigation line can be determined, and if such navigation point exists, the map element where the navigation point is located can be determined as calibrated wrongly. A comparison of a correct calibration and a wrong calibration determined according to the curvature of the navigation line is shown in FIG. 7A and FIG. 7B. There is no navigation point with a curvature greater than the predetermined value on the navigation line (indicated by the dashed line) in FIG. 7A, and the corresponding map element is calibrated correctly. However, there is a navigation point A with a curvature greater than the predetermined value on the navigation line in FIG. 7B, so one or more map elements in an area where the navigation point A is located are calibrated wrongly.

In the embodiments of the present disclosure, four kinds of static calibration errors can be detected according to the feature information of the map element, and a dynamic calibration error can be detected according to the navigation line. Through the above manners, the dynamic calibration error in a high definition map can be automatically detected from the perspective of path planning, and the automatic detection on a map calibration error is realized, which reduces the detection cost and improves the detection accuracy.

A person skilled in the art may understand that, in the described method of the specific implementation, the drafting order of each step does not imply that the strictly executed order forms any limitation to the implementation process, and the specific execution order of each step should be determined by its function and possibly intrinsic logic.

As shown in FIG. 8, the present disclosure further provides an apparatus including: an acquiring unit 801, configured to acquire a map which includes at least one map element; a determining unit 802, configured to determine feature information of the at least one map element, or determine a navigation line according to the map; and a determining unit 803, configured to determine whether a map element is calibrated wrongly according to the feature information or the navigation line.

In some embodiments, the at least one map element includes a plurality of map points and the feature information includes relative position information between each two of the plurality of map points; the determining unit is configured to determine whether there is a duplicate map point on the map according to pieces of the relative position information; and determine, in a case that there is the duplicate map point, that the duplicate map point is calibrated wrongly.

In some embodiments, the at least one map element includes a junction and the feature information includes lane link information of the junction; the determining unit is configured to determine that a junction of which lane link information is empty is calibrated wrongly.

In some embodiments, the at least one map element includes boundary points of a junction or boundary points of a section and the feature information includes a geometric feature of a boundary constituted by the boundary points; the determining unit is configured to determine whether the boundary constitutes a predetermined polygon according to the geometric feature; and determine, in a case that the boundary does not constitute the predetermined polygon, that the boundary is calibrated wrongly.

In some embodiments, the at least one map element includes a plurality of sections in a road, the feature information includes a first distance between each of the sections and a predecessor junction of the road and a second distance between each of the sections and a successor junction of the road; the determining unit is configured to determine, from a plurality of sections, that a section failing to meet a predetermined constraint condition is calibrated wrongly; the predetermined constraint condition includes: the first distance increases as numbering of the sections increases, and the second distance decreases as the numbering of the sections increases.

In some embodiments, the apparatus further includes a first determining unit, configured to determine, in a case that there is a map element calibrated wrongly, a calibration error type of the wrongly calibrated map element; a second determining unit, configured to determine an alarm level according to the calibration error type; and an outputting unit, configured to output alarm information corresponding to the alarm level.

In some embodiments, the acquiring unit includes a selecting unit, configured to select a starting point, an ending point, and a passing point from the map; and a generating unit, configured to generate the navigation line according to the starting point, the ending point, and the passing point.

In some embodiments, the selecting unit is configured to select, according to weights of one or more target areas divided from the map, the starting point, the ending point, and the passing point from the one or more target areas, where a target area includes a road or a junction.

In some embodiments, the weights are predetermined according to frequencies of use of the one or more target areas; or a weight of each of the target areas is randomly allocated according to a predetermined distribution function.

In some embodiments, the determining unit is further configured to determine, in a case that there is an intersection point between the navigation line and any map element, that the map element intersected with the navigation line is calibrated wrongly.

In some embodiments, the determining unit is further configured to determine whether there is a navigation point with a curvature greater than a predetermined value on the navigation line; and determine, in a case that there is the navigation point with the curvature greater than the predetermined value, that a corresponding map element in an area where the navigation point is located is calibrated wrongly.

In some embodiments, the apparatus provided by embodiments of the present disclosure has functionality or contains modules that can be used to perform the methods described in the method embodiments above, the specific implementation of which can be described with reference to the method embodiments above and will not be repeated herein for brevity.

The apparatus embodiments described above are merely schematic, in which the modules described as separate components may or may not be physically separated, and the components displayed as modules may or may not be physical modules, that is, may be located in one place or distributed to a plurality of network modules. Some or all of the modules can be selected according to practical needs to realize the purpose of the solution in the present specification. Those of ordinary skill in the art can understand and implement without creative work.

The apparatus embodiments in this specification can be applied to a computer device, such as a server or a terminal device. The apparatus embodiments can be implemented by software, or can be implemented by hardware or a combination of software and hardware. Taking software implementation as an example, as a logical device, it is formed by reading the corresponding computer program instructions in a non-volatile memory into a memory through a processor that processes a file where it is located. From a hardware perspective, as shown in FIG. 9, which is a hardware structure diagram of a computer device where the device of this specification is located. Besides the processor 901, the memory 902, the network interface 903 and the non-volatile memory 904 shown in FIG. 9, the server or electronic device where the device is located in the embodiment usually includes other hardware according to the actual function of the computer device, which will not be elaborated here.

Accordingly, the embodiments of the present disclosure further provide a computer readable storage medium having a computer program stored thereon, where the program is executed by a processor to perform the method according to any one of the embodiments.

Accordingly, the embodiments of the present disclosure further provide a computer device, which includes a memory, a processor, and a computer program stored on the memory and executable on the processor, when the computer program is executed by the processor, the method according to any one of the embodiments can be implemented.

The present disclosure can take the form of a computer program product implemented on one or more storage media containing program codes (including but not limited to disk storage, CD-ROM, optical storage, etc.). The computer readable medium includes permanent and non-permanent, removable and non-removable medium, and information storage can be realized by any method or technology. The information can be computer readable instructions, data structures, program modules, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, CD-ROM, digital versatile disc (DVD) or other optical storage, magnetic cassettes, magnetic tape storage or other magnetic storage devices or any other non-transmission media can be used to store information that can be accessed by computing devices. According to the definition in this article, the computer readable medium does not include transitory medium, such as modulated data signals and carrier waves.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the present technical field that not disclosed in the present disclosure. The specification and examples are considered as exemplary only, with a true scope and spirit of the present disclosure being indicated by the following claims.

It should be understood that the present disclosure is not limited to the precise structure described above and shown in the accompanying drawings, and that various modifications and changes can be made without departing from the scope thereof. The scope of the present disclosure is limited only by the appended claims.

The above are only preferred embodiments of the present disclosure, and are not used to limit the present disclosure. Any modification, equivalent replacement, improvement within the spirit and principle of the present disclosure shall be included in the protection scope of the present disclosure.

The above description of the various embodiments tends to emphasize the differences between the various embodiments, the same or similarities can be referred to each other, which will not be repeated for the sake of brevity.

1. A method of detecting a map calibration error, comprising:
acquiring a map including at least one map element;
determining at least one of feature information of the at least one map element or a navigation line according to the map; and
determining whether a map element is calibrated wrongly according to the at least one of the feature information or the navigation line.

2. The method according to claim 1, wherein the at least one map element comprises a plurality of map points, and the feature information comprises relative position information between each two of the plurality of map points,
wherein determining whether the map element is calibrated wrongly according to the at least one of the feature information or the navigation line comprises:
determining whether there is a duplicate map point on the map according to the relative position information associated with the plurality of map points, and
wherein the method further comprises:
in response to determining that there is a duplicate map point on the map, determining that the duplicate map point is calibrated wrongly.

3. The method according to claim 1, wherein the at least one map element comprises a junction, and the feature information comprises lane link information of the junction,
wherein determining whether the map element is calibrated wrongly according to the at least one of the feature information or the navigation line comprises:
determining whether lane link information of the junction is empty, and
wherein the method further comprises:
in response to determining that the lank link information of the junction is empty, determining that the junction is calibrated wrongly.

4. The method according to claim 1, wherein the at least one map element comprises at least one of boundary points of a junction or boundary points of a section, and the feature information comprises a geometric feature of a boundary constituted by the boundary points,
wherein determining whether the map element is calibrated wrongly according to the at least one of the feature information or the navigation line comprises:
determining whether the boundary constitutes a predetermined polygon according to the geometric feature, and
wherein the method further comprises:
in response to determining that the boundary does not constitute the predetermined polygon, determining that the boundary is calibrated wrongly.

5. The method according to claim 1, wherein the at least one map element comprises a plurality of sections in a road,
wherein the feature information comprises:
a first distance between each of the plurality of sections and a predecessor junction of the road and
a second distance between each of the plurality of sections and a successor junction of the road,
wherein each of the plurality of sections has a respective section identifier increasing along a direction from the predecessor junction to the successor junction; and
wherein determining whether the map element is calibrated wrongly according to the at least one of the feature information or the navigation line comprises:
determining, among the plurality of sections, whether a section fails to meet a predetermined constraint condition,
wherein the predetermined constraint condition comprises: the section having a larger first distance than a first section with a first section identifier smaller than a section identifier of the section, and the section having a smaller second distance than a second section with a second section identifier smaller than the section identifier of the section.

6. The method according to claim 1, further comprising:
in response to determining that a map element is calibrated wrongly, determining a calibration error type of the map element that is calibrated wrongly;
determining an alarm level according to the calibration error type; and
outputting alarm information corresponding to the alarm level.

7. The method according to claim 1, wherein determining the at least one of the feature information of the at least one map element or the navigation line according to the map comprises:
selecting a starting point, an ending point, and a passing point from the map; and
generating the navigation line according to the starting point, the ending point, and the passing point.

8. The method according to claim 7, wherein selecting the starting point, the ending point, and the passing point from the map comprises:
selecting, according to weights of one or more target areas divided from the map, the starting point, the ending point, and the passing point from the one or more target areas, wherein a target area comprises a road or a junction.

9. The method according to claim 8, further comprising one of:
determining the weights of the one or more target areas according to corresponding frequencies of use of the one or more target areas; or
randomly allocating the weights of the one or more target areas according to a predetermined distribution function.

10. The method according to claim 1, wherein determining whether the map element is calibrated wrongly according to the at least one of the feature information or the navigation line comprises:
determining whether there is an intersection point between the navigation line and the map element, and
wherein the method further comprises:
in response to determining that there is an intersection point between the navigation line and the map element, determining that the map element intersected with the navigation line is calibrated wrongly.

11. The method according to claim 1, wherein determining whether the map element is calibrated wrongly according to the at least one of the feature information or the navigation line comprises:
determining whether there is a navigation point with a curvature greater than a predetermined value on the navigation line; and
in response to determining that there is a navigation point with a curvature greater than the predetermined value on the navigation line, determining whether the map element corresponds to the navigation point and is in an area where the navigation point is located,
wherein the method further comprises:
in response to determining that the map element corresponds to the navigation point and is in the area where the navigation point is located, determining that the map element is calibrated wrongly.

12. A non-transitory computer-readable storage medium coupled to at least one processor having machine-executable instructions stored thereon that, when executed by the at least one processor, cause the at least one processor to perform operations comprising:
acquiring a map including at least one map element;
determining at least one of feature information of the at least one map element or a navigation line according to the map; and
determining whether a map element is calibrated wrongly according to the at least one of the feature information of the at least one map element or the navigation line according to the map.

13. A computer device, comprising:
at least one processor; and
at least one non-transitory machine readable storage medium coupled to the at least one processor having machine-executable instructions stored thereon that, when executed by the at least one processor, cause the at least one processor to perform operations comprising:
acquiring a map including at least one map element;
determining at least one of feature information of the at least one map element or a navigation line according to the map; and
determining whether a map element is calibrated wrongly according to the at least one of the feature information of the at least one map element or the navigation line according to the map.

14. The computer device according to claim 13, wherein the at least one map element comprises a plurality of map points, and the feature information comprises relative position information between each two of the plurality of map points, and
wherein the operations comprise:
determining whether there is a duplicate map point on the map according to the relative position information associated with the plurality of map points; and
in response to determining that there is a duplicate map point on the map, determining that the duplicate map point is calibrated wrongly.

15. The computer device according to claim 13, wherein the at least one map element comprises a junction, and the feature information comprises lane link information of the junction, and
wherein the operations comprise:
determining whether lane link information of the junction is empty; and
in response to determining that the lank link information of the junction is empty, determining that the junction is calibrated wrongly.

16. The computer device according to claim 13, wherein the at least one map element comprises at least one of boundary points of a junction or boundary points of a section, and the feature information comprises a geometric feature of a boundary constituted by the boundary points,
wherein the operations comprise:
determining whether the boundary constitutes a predetermined polygon according to the geometric feature; and
in response to determining that the boundary does not constitute the predetermined polygon, determining that the boundary is calibrated wrongly.

17. The computer device according to claim 13, wherein the at least one map element comprises a plurality of sections in a road,
wherein the feature information comprises:
a first distance between each of the plurality of sections and a predecessor junction of the road and
a second distance between each of the plurality of sections and a successor junction of the road,
wherein each of the plurality of sections has a respective section identifier increasing along a direction from the predecessor junction to the successor junction; and
wherein determining whether the map element is calibrated wrongly according to the at least one of the feature information or the navigation line comprises:
determining, among the plurality of sections, whether a section fails to meet a predetermined constraint condition,
wherein the predetermined constraint condition comprises: the section having a larger first distance than a first section with a first section identifier smaller than a section identifier of the section, and the section having a smaller second distance than a second section with a second section identifier smaller than the section identifier of the section.

18. The computer device according to claim 13, wherein the operations further comprise:
in response to determining that a map element is calibrated wrongly, determining a calibration error type of the map element that is calibrated wrongly;
determining an alarm level according to the calibration error type; and
outputting alarm information corresponding to the alarm level.

19. The computer device according to claim 13, wherein determining the at least one of the feature information of the at least one map element or the navigation line according to the map comprises:
selecting a starting point, an ending point, and a passing point from the map; and
generating the navigation line according to the starting point, the ending point, and the passing point.

20. The computer device according to claim 13, wherein the operations comprise:
determining whether there is an intersection point between the navigation line and the map element; and
in response to determining that there is an intersection point between the navigation line and the map element, determining that the map element intersected with the navigation line is calibrated wrongly.
